(19) United States
(12) Patent Application Publication
(10) Pub. No.: US 2009/0211136 A1
(43) Pub. Date: Aug. 27, 2009

(54) Apparatus and method for locating people

(76) Inventor: Eileen A. O'Connor, Narragansett, RI (US)

Correspondence Address: LAURA G. BARROW, P.O. BOX 215, ESTERO, FL, 33928, US

(21) Appl. No.: 12/072,170

(22) Filed: Feb. 25, 2008

(51) Int. Cl. G09F 7/00; A44C 5/00

(52) U.S. Cl. 40/633; 40/606.01

(57) ABSTRACT

Apparatus, kits, systems, and methods for assisting people in locating a desired meeting place are disclosed herein. In certain embodiments, the present invention is particularly useful in helping children or adults with diminished mental capacity to locate rather easily an area designated as a meeting place in the event the child or adult gets lost. Preferred embodiments include the use of visual display apparatus and band to be worn by person, the visual display apparatus and band having visually matching designs to aid the person wearing the band in locating the desired meeting place. Other embodiments of the present invention include the use of a web-based system for transmitting and viewing the designs of the visual display apparatus to others, including means for downloading and printing the designs.

### SUMMARY OF THE INVENTION

The present invention, in certain aspects, is directed to a method for assisting a person in locating a selected meeting place with other people, the method comprising (a) placing a visual display apparatus at a selected meeting place, the visual display apparatus having a recognizable visual design; (b) securing a band to a person desiring to locate the meeting place, the band having a design substantially identical to the visual display apparatus design; whereby the person wishing to locate the visual display apparatus does so by matching the band design with that visual display apparatus having the visual display design. The visual display apparatus may comprise a pole having a top end with a flag secured to the pole at or near the top end. In addition, the band may be worn on the person's arm. The designs may comprise a single color or comprise two or more color combinations arranged in a particular pattern.

The present invention is also directed to a kit for assisting a person in locating a selected meeting place with other people. The kit comprises (a) a visual display apparatus having a recognizable visual design; and (b) at least one band adapted to be worn by a person desiring to locate a selected meeting place, the band having a design substantially identical to the visual display apparatus design. As described above, the visual apparatus my comprise a pole and at least one flag, the flag being secured to the pole or adapted for being secured to the pole. The designs of the visual display apparatus and band may comprise a single color or comprise two or more color combinations arranged in a particular pattern.

Other aspects of the present invention include a system for assisting a person in locating a selected meeting place, the system comprising (a) a visual display apparatus having a recognizable visual design; and (b) an Internet web-site comprising screenshots of the visual display apparatus designs or downloadable documents containing the visual display designs; whereby a person desiring to locate a selected meeting place may view the designs or download the documents from the web-site for viewing in order to help the person locate the visual display apparatus at the meeting place. As discussed above, the visual display apparatus may comprises a pole and at least one flag, the flag being secured to the pole or adapted for being secured to the pole. The designs may comprise a single color or comprise two or more color combinations arranged in a particular pattern.

Other aspects of the present invention include a method for assisting a person in locating a selected meeting place with other people, the method comprising, in either order, (a) placing a visual display apparatus at a selected meeting place, the visual display apparatus having a recognizable visual design; (b) providing an Internet web-site comprising screen shots of the visual display designs, wherein the screen shots show the visual display apparatus designs or provide links to documents containing the visual display apparatus designs, whereby a person accessing the web-site may download the document for viewing; (c) transmitting all or a portion of the web-site screenshots or documents to one or more people desiring to locate the selected meeting place; and (d) locating the visual display apparatus by matching the web-site design with the visual display apparatus having the visual display apparatus design. The visual display apparatus may comprise a pole and at least one flag, the flag being secured to the pole or adapted for being secured to the pole. The designs may comprise a single color or comprise two or more color combinations arranged in a particular pattern.

### BRIEF DESCRIPTION OF THE DRAWINGS

FIG. 1 is a front schematic view of an exemplary flag and flag design of the present invention.

FIG. 2 is a front schematic view of a wrist or arm band for use in the present invention, the arm band.

FIG. 3 is an exemplary screen shot of a website page for use in certain aspects of the present invention.

FIG. 4 is illustrates a beach crowded with people, including a person wearing the arm band of FIG. 2 and further including a visual display apparatus secured at a desired meeting location on the beach.

### DETAILED DESCRIPTION OF THE PREFERRED EMBODIMENTS

The present invention is directed to an apparatus, kits, and methods for assisting people in locating a desired meeting place. In certain embodiments, the present invention is particularly useful in helping children or adults with diminished mental capacity to locate rather easily an area designated as a meeting place in the event the child or adult gets lost.

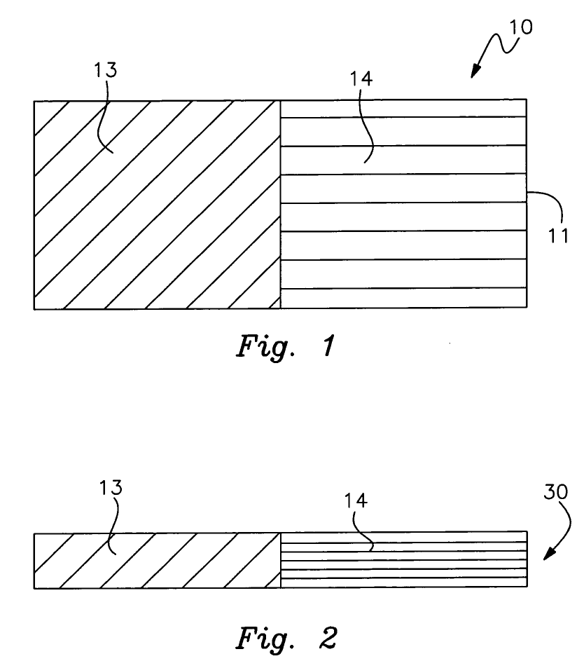

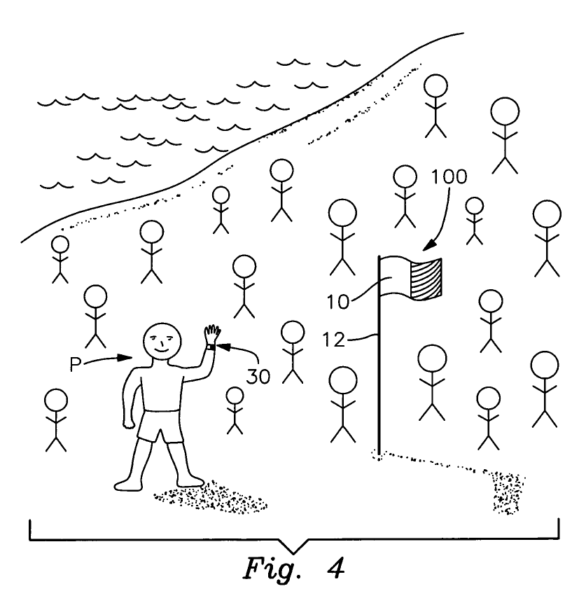

Referring now to the figures, the present invention, in certain aspects, comprises a visual display apparatus 100 that is configured to be placed in or around a selected meeting place 20 (such as the beach, as shown in FIG. 4). A portion of the visual display apparatus comprises a recognizable visual design 11, preferably a design that is different from designs of similar objects in the area. A preferred visual display apparatus is a flag 10 secured to a pole 12, preferably an elongated pole, as shown in FIG. 1. Here, the flag contains the recognizable visual design which may be a combination of two-dimensional geometric shapes and/or colors. The flag in FIG. 1 shows two rectangles with two different colors 13, 14, one of which may be white. It will be appreciated by those of ordinary skill in the art that virtually any pattern of lines, shapes, and/or colors may be used, although it is preferred that distinctive designs or color combinations that differ from flags or signs in the general area of the meeting place, for example, be used to avoid confusion. For use in helping young children or illiterate or mentally handicapped adults locate the selected meeting place, various patterns or colors are desired, although flags containing visible text may be used, alone or in combination with various two-dimensional patterns and/or color schemes in order to assist children and adults who can read the language of the text.

FIG. 1 shows the use of a single flag attached at or near the top of a flag pole; however, it will be appreciated by those of ordinary skill in the art that multiple flags may be used and arranged along the pole. Flags of different configurations, as well as other types of visual displays, including, but not limited to, signs, posters, wind sacks or tubes, ribbons, and the like. For ease of explanation, however, the term “flag” is used herein to refer to the component of the visual display apparatus that incorporates the distinctive visual design.

The flag may be secured to an elongated pole 12, as shown in FIG. 1. The pole may be one solid piece, preferably having a length of at least six feet so it can be more easily viewed in a crowded area. Alternatively, the pole may comprise of two or more separate pieces (not shown) that can be connect to one another. This latter embodiment is preferable when the present invention is provided as a kit. Similarly, the pole may be telescopic device (not shown), which can be reduced in size for storage and then extended to the desired length prior to use. Again, this third embodiment is also preferable when the present invention is provided as a kit. The pole may be fabricated of metal, plastic, or any other suitable material known by those of skill in the art. The pole may implanted directly into the ground, such as at a park or beach, secured to a solid, weighted stand, or secured to another apparatus, such as a car, table, chair, fence, building, and the like. In lieu of a pole, the flag or similar component of the display apparatus may attached to a wooden, metal, or plastic post or stud, or any other device suitable for securing the flag. Similarly, the flag could be secured to an existing pole, stud, building, sign, and the like that has a sufficient height so as to allow a person to readily view the flag displaying the distinctive design.

The present invention also includes, in certain embodiments, the use of bands 30 or similar devices that are adapted to be worn by a person P desiring to locate the selected meeting place. While the term “band” will be used herein, it will be recognized that any type of device that may be worn or secured to the person, even if carried in the person's apparel (e.g. a pocket), may be employed. A preferred band is one that may be secured via VELCRO (hook/loop), snaps, buttons, adhesives, and the like. The band may be worn on an arm or wrist band that can simply be slipped over the person's hand/arm and worn without any additional fastening, like a bracelet, and in such an embodiment, the band would be fabricated of an elastomeric material, allowing the band to stretch over the hand. Regardless of the type of band used, the band further comprises a design 31 imprinted or attached thereon, the design being identical, or substantially identical to, the design displayed on the flag or other type of visual display apparatus. The term “substantially” is used herein as a qualifier, since practically speaking, there may be slight differences in color intensities or shades (e.g. an orange color may appear darker on the band than on the flag, or vice versa), boldness of lines, or slight differences in relevant sizes of objects, shapes, text, etc. displayed on the designs of the flags and bands.

The present invention may be used at any time and in any location, but is particularly useful in an area (indoors or outdoors) where there are large crowds of people (e.g. beaches, parks, amusement parks, convention centers, stadiums, and the like). FIG. 4 illustrates the pole being used at a crowded beach. The visual display apparatus is placed at a desired meeting location where it can be readily seen at a substantial distance. One or people are given a band that may be worn as described above. The persons wearing the band are instructed to look for the flag, for example, that bears the same design as the design displayed on their band. As discussed above, the present invention is particularly useful for young children or illiterate adults (or adults of diminished mental capacity), who know they only have to search for a flag with the distinctive design or color scheme.

The dimensions and configuration of the visual display apparatus and bands may vary. Preferable sizes for the flag are 12 in.×18 in., which is a good size for visibility (although the flag may be larger or smaller and non-rectangular). Similarly, the band may be of any desired size, regardless of whether it is worn or carried by the person. An exemplary wrist band size is 1 in.×6 in. Any variety of materials or fabrics may be employed for fabricating the visual display apparatus and bands that are known by those of ordinary skill in the art.

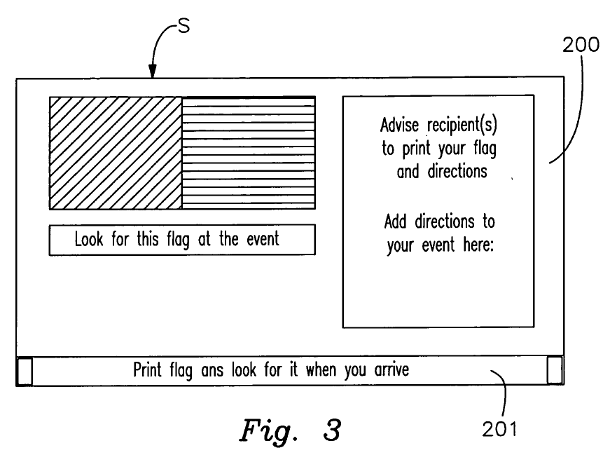

Other aspects of the present invention include the use of a web-based Internet system, whereby a web-site comprises computer screen shots 200 of the visual display apparatus designs that may be displayed on a computer screen S. The website may also include links to downloadable or printable documents that may be downloaded by the user of the site from a specific button 201, for example, the documents displaying the designs. Other types of information may be provided on the website, such as instructions for using the designs, information regarding different designs for different meeting locations, dates of various events, directions to various events, and the like (see FIG. 3). A person desiring access to the designs simply accesses the website and either simply views the designs, or preferably prints out the screen shots (or downloads the documents) containing the designs. Other embodiments include downloadable bands that may be printed out on heavy paper, for example, and subsequently constructed to wrap around a person's wrist or arm, for example, via an adhesive. Operators of the website (e.g. webmasters) or organizers of a meeting or outing (e.g. teachers organizing a class field trip for children) may transmit, via electronic mail, the designs to participants (or their parents, for example), of the event, for subsequent printout (as opposed to the person desiring access to the designs having to log onto the website).

With respect to the use of the Internet to display and transmit the designs of the present invention to others, it will be recognized by those of ordinary skill in the art that conventional computer programs used for the design and launching of web pages over the Internet may be employed in the present invention and are therefore commonly known by the skilled artisan. Consequently, no further description with respect to the creation and implementation of those computer programs is required herein to practice the present invention. Moreover, the typical website functions or features for displaying screen shots, uploading and downloading files and documents, and printing said files and documents or screen shots are commonly known by those of ordinary skill in the art and may be employed in the present invention. The figures contained herein illustrate only exemplary screen shots and web designs.

I claim:

1. A method for assisting a person in locating a selected meeting place with other people, said method comprising:
a) placing a visual display apparatus at a selected meeting place, said visual display apparatus having a recognizable visual design;
b) securing a band to a person desiring to locate said meeting place, said band having a design substantially identical to said visual display apparatus design; and
c) said person locating said visual display apparatus by matching said band design with that visual display apparatus having said visual display design.

2. The method of claim 1, wherein said visual display apparatus comprises a pole having a top end, and a flag secured to said pole at or near said top end.

3. The method of claim 1, wherein said band is worn on said person's arm.

4. The method of claim 1, wherein said designs comprise a single color.

5. The method of claim 1, wherein said designs comprise two or more color combinations arranged in a particular pattern.

6. A kit for assisting a person in locating a selected meeting place with other people, said kit comprising:
a) a visual display apparatus having a recognizable visual design; and
b) at least one band adapted to be worn by a person desiring to locate a selected meeting place, said band having a design substantially identical to said visual display apparatus design.

7. The kit of claim 6, wherein said visual display apparatus comprises a pole and at least one flag, said at least one flag secured to said pole or adapted for being secured to said pole.

8. The kit of claim 6, wherein said designs comprise a single color.

9. The kit of claim 6, wherein said designs comprise two or more color combinations arranged in a particular pattern.

10. A system for assisting a person in locating a selected meeting place, said system comprising:
a) a visual display apparatus having a recognizable visual design; and
b) an Internet web-site comprising screenshots of said visual display apparatus designs or downloadable documents containing said visual display designs;
whereby a person desiring to locate a selected meeting place may view said designs or download said documents from said web-site for viewing in order to help said person locate said visual display apparatus at said meeting place.

11. The system of claim 10, wherein said visual display apparatus comprises a pole and at least one flag, said at least one flag secured to said pole or adapted for being secured to said pole.

12. The system of claim 10, wherein said designs comprise a single color.

13. The system of claim 10, wherein said designs comprise two or more color combinations arranged in a particular pattern.

14. A method for assisting a person in locating a selected meeting place with other people, said method comprising, in either order:
a) placing a visual display apparatus at a selected meeting place, said visual display apparatus having a recognizable visual design;
b) providing an Internet web-site comprising screen shots of said visual display designs, wherein said screen shots show said visual display apparatus designs or provide links to documents containing said visual display apparatus designs, whereby a person accessing said web-site may download said document for viewing;
c) transmitting all or a portion of said web-site screenshots or documents to one or more people desiring to locate said selected meeting place; and
d) locating said visual display apparatus by matching said web-site design with said visual display apparatus having said visual display apparatus design.

15. The method of claim 14, wherein said visual display apparatus comprises a pole and at least one flag, said at least one flag secured to said pole or adapted for being secured to said pole.

16. The method of claim 14, wherein said designs comprise a single color.

17. The method of claim 14, wherein said designs comprise two or more color combinations arranged in a particular pattern.
